(19) United States
(12) Patent Application Publication
(10) Pub. No.: US 2018/0020081 A1
(43) Pub. Date: Jan. 18, 2018

(54) Managing a Parameter of an Unmanned Autonomous Vehicle Based on Manned Aviation Data

(71) Applicant: QUALCOMM Incorporated, San Diego, CA (US)

(72) Inventor: Edward Harrison Teague, San Diego, CA (US)

(21) Appl. No.: 15/331,561

(22) Filed: Oct. 21, 2016

Related U.S. Application Data
(60) Provisional application No. 62/362,838, filed on Jul. 15, 2016.

(51) Int. Cl. H04L 29/08; B64D 47/08; B64C 39/02; H04W 84/12; H04W 4/00; H04W 84/04

(52) U.S. Cl. CPC H04L 67/34; H04L 67/12; B64D 47/08; B64C 39/024; B64C 2201/141; B64C 2201/127; H04W 4/008; H04W 84/042; H04W 84/12

(57) ABSTRACT

Embodiments include devices and methods for an unmanned autonomous vehicle (UAV) to receive manned aviation data from communication equipment available on the UAV without requiring the use of manned aviation radios and transponder equipment. A processor of the UAV may receive manned aviation data over a communication link with a communication network (e.g., the Internet) coupled to a server or network element that has access to manned aviation data. Communications with the communication network may be accomplished via the same communication channels used to transmit and receive mission-critical and payload communications. The processor may analyze the manned aviation data stream to obtain and identify relevant data, and may adjust a parameter of the UAV based on the analyzed manned aviation data stream. In various embodiments, the processor of the UAV may send UAV flight information to the communication network for inclusion in a manned aviation radio system broadcast.

### RELATED APPLICATIONS

This application claims the benefit of priority to U.S. Provisional Application No. 62/362,838 entitled “Managing a Flight Parameter of an Unmanned Autonomous Vehicle Based on Manned Aviation Data” filed Jul. 15, 2016, the entire contents of which are hereby incorporated by reference.

### BACKGROUND

Unmanned aerial vehicles (UAVs), sometimes referred to as “drones,” are being developed for a wide range of applications. It is expected that large numbers of UAVs may someday occupy the airspace below general and commercial aviation (e.g., at 500 feet or less). UAVs tend to be small with limited payload carrying capability. Some UAVs are powered by multiple fixed-pitch rotors driven by controllable electric motors, providing take-off, hover, landing, and flight capabilities with a high degree of control and freedom.

Due to the limited payload capacity of UAVs, lightweight communication systems are preferred. For example, UAVs may be equipped to communicate with cellular communication networks (e.g., 3G, 4G, and/or 5G communication networks) and/or local area wireless networks, such as WiFi networks. Since UAVs fly at relatively low altitudes, UAV communications may use ground-based cellular networks for communication. However, the limited payload capacity of UAVs prohibits equipping UAVs with specialty radios used in commercial and general aviation aircraft to receive information from aviation radio networks. Thus, UAVs are conventionally unable to benefit from information transmitted over aviation networks that is available manned aircraft, such as real-time air traffic information and weather information.

### SUMMARY

Various embodiments include methods that may be implemented on UAVs and network elements for managing a parameter of a UAV based on manned aviation data. Various embodiments may include receiving over a communication link with a communication network a manned aviation data stream, analyzing the manned aviation data stream, and adjusting a parameter of the UAV based on the analyzed manned aviation data stream. In some embodiments, adjusting the parameter of the UAV based on the analyzed manned aviation data stream may include determining whether information relevant to the UAV is included in the analyzed manned aviation data stream, and adjusting the parameter of the UAV based on the information relevant to the UAV in response to determining that information relevant to the UAV is included in the analyzed manned aviation data stream. In some embodiments, adjusting the parameter of the UAV based on the analyzed manned aviation data may include adjusting a flight parameter of the UAV, a sensor parameter of the UAV, or a camera parameter of the UAV.

In some embodiments, the communication link with the communication network may include a cellular data communication link. In some embodiments, the communication network may include the Internet. In some embodiments, receiving over the communication link with the communication network the manned aviation data stream may include receiving the manned aviation data stream over the same communication link over which one of mission critical communications and payload communications is received. In some embodiments, receiving over the communication link with the communication network the manned aviation data stream may include receiving the manned aviation data stream from a network element of the communication network. In some embodiments, the manned aviation data stream comprises information from a manned aviation radio system. In some embodiments, the manned aviation data stream may include Automatic Dependent Surveillance-Broadcast (ADS-B) data or Mode S transponder system data. In some embodiments, adjusting the parameter of the UAV based on the analyzed manned aviation data stream may include changing one or more of a flight direction, a flight speed, and an altitude based on the analyzed manned aviation data stream.

Various embodiments include methods that may be implemented on UAVs of communicating flight information from a UAV to a manned aviation information system. Various embodiments may include establishing a communication link between the UAV and a communication network, and sending UAV flight information to a network element of the communication network for inclusion in a broadcast by a manned aviation information system.

In some embodiments, sending UAV flight information to a network element of the communication network may include sending the flight information over the same communication link over which one of mission critical communications and payload communications is transmitted. In some embodiments, establishing the communication link between the UAV and the communication network may include providing authentication credentials to verify a permission of the UAV to provide the UAV flight information to the manned aviation information system. In some embodiments, sending the UAV flight information to a network element of the communication network for inclusion in the broadcast of a manned aviation radio system may include formatting the UAV flight information into a format usable by the manned aviation radio system. In some embodiments, the UAV flight information may include one or more of location information, altitude information, course information, speed information, and sensor information. In some embodiments, the communication link between the UAV and a communication network may include a cellular data communication link.

Further embodiments may include a UAV including a radio module, an avionics module, and a processor coupled to the radio module and the avionics module and configured with processor-executable instructions to perform operations of the methods described above, and/or a network element including a network interface and a processor coupled to the network interface and configured with processor-executable instructions to perform operations of the methods described above. Further embodiments may include a UAV and/or a network element including means for performing functions of the methods described above. Further embodiments may include processor-readable storage media on which are stored processor executable instructions configured to cause a processor of a mobile communication device to perform operations of the methods described above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram of a communication system according to various embodiments.

FIG. 2 is a component block diagram illustrating components of a UAV according to various embodiments.

FIG. 3 is a process flow diagram illustrating a method of managing a parameter of a UAV according to various embodiments.

FIG. 4 is a process flow diagram illustrating a method of communicating flight information from a UAV to a manned aviation information system according to various embodiments.

FIG. 5 is a component block diagram illustrating a network element according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments provide methods implemented by a processor in a UAV for accessing data otherwise available to general and commercial aircraft using communication resources available to the UAV by leveraging networks (e.g., the Internet) in which such information may be stored. The UAV may use such manned aviation data to manage flight operations of the UAV. Various embodiments also provide methods implemented by a processor in a UAV for communicating UAV flight information to a manned aviation information system using communication resources available to the UAV. Various embodiments enable UAVs to benefit from and contribute to aviation data streams provided for general and commercial aviation without having to carry the heavy communication equipment required to receive such data streams directly.

As used herein, the term “UAV” refers to one of various types of unmanned aerial vehicles. A UAV may include an onboard computing device configured to fly and/or operate the UAV without remote operating instructions (i.e., autonomously), such as from a human operator or remote computing device. Alternatively, the onboard computing device may be configured to fly and/or operate the UAV with some remote operating instruction or updates to instructions stored in a memory of the onboard computing device. A UAV may be propelled for flight using one of a plurality of propulsion units, each including one or more rotors, that provide propulsion and/or lifting forces for the UAV. In addition, a UAV may include wheels, tank-tread, or other non-aerial movement mechanisms to enable movement on the ground or through water. UAV propulsion units may be powered by one or more types of electric power sources, such as batteries, fuel cells, motor-generators, solar cells, or other sources of electric power, which may also power the onboard computing device, navigation components, and/or other onboard components.

Manned aviation radio networks provide a variety of flight information to aircraft. The aviation data streams carried over such aviation radio networks may provide general and commercial aircraft with navigation information, information about nearby air traffic, local weather conditions and forecasts, convenience information, such as Notices to Airmen (NOTAM), and other such information. Manned aviation radio information is typically broadcast over a variety of radio networks, very high frequency (VHF) and ultrahigh frequency (UHF) radio channels, and radar frequencies such as the Automatic Dependent Surveillance-Broadcast (ADS-B) and the Mode S transponder system. Typically, specialized certified radio equipment is required to receive each of the various types of manned aviation data streams. Such specialized radio equipment is readily installed in manned aircraft that have large payload capacities.

On the other hand, the comparatively limited capacity of UAVs prohibits equipping UAVs with the specialized radios to receive information from aviation radio networks. UAVs are commonly used in a variety of applications, including surveying, photography, power or communications repeater functions, and delivery, among other things, and are increasingly equipped to communicate with cellular communication networks, such as 3G, 4G, and/or 5G wireless telephony communication networks, as well as local area wireless networks based on Wi-Fi. The use of cellular communication networks is feasible for UAVs because UAVs fly at relatively low altitudes, and thus fly close to ground-based cellular networks. Such wireless communication equipment tends to be small and lightweight, as evidenced by modern smartphones.

UAVs may require or benefit from access to information that is currently available over manned aviation radio networks, such as real-time air traffic information and weather information. However, the various radio receivers necessary to receive the different manned aviation radio broadcasts and data streams are very heavy compared to the payload carrying capacity of UAVs, and typically function poorly at the low altitudes flown by most UAVs. Thus, conventionally UAVs are not able to receive information from manned aviation radio networks.

Various embodiments provide methods implemented by a processor in a UAV using the cellular network communications equipment generally available on UAVs for accessing a network, such as the Internet, from which manned aviation data may be received indirectly. In various embodiments, the processor of the UAV may receive a manned aviation data stream from a server storing such data via a cellular network communications link with a ground station providing access to the server via a ground-based communication network (e.g., the Internet). The manned aviation data stream may include any aviation data that is obtained by a server from a manned aviation radio system (such as, for example, the ADS-B system or the Mode S system), and maintained or streamed for access by a variety of computing devices. The manned aviation data stream may include information such as information about traffic around the UAV (e.g., vectors and altitudes of other vehicles, including manned vehicles and/or other UAVs). The manned aviation data stream may also include information such as weather information, and other information relevant to operations of the UAV, such as NOTAMs and other similar information.

In various embodiments, the UAV may receive the manned aviation data stream from a server or another network element of the communication system. In some embodiments, the server or network element of the communication system may access and/or receive the information from the manned aviation radio system and may generate the manned aviation data stream. In some embodiments, the UAV may receive the manned aviation data stream over the same communication link over which the UAV receives mission critical communications and/or payload communications. Thus, in such embodiments, the UAV may receive the manned aviation data stream, mission critical communications, and/or payload communications over a common communication link.

In some embodiments, the processor of the UAV may analyze the manned aviation data stream to determine whether the analyzed manned aviation data stream includes any information relevant to the UAV. For example, the processor may identify relevant information about traffic around the UAV, such as information about an approaching aircraft (e.g., that will intersect a flight path of the UAV, that is on a collision course, etc.). As another example, the processor may identify relevant weather information, such as an approaching storm. As another example, the processor may identify information detailing restricted travel areas (e.g., restricted airspace), hazards to navigation, or other similar information.

In some embodiments, the processor of the UAV may adjust a parameter of the UAV based on the information in the manned aviation data stream. In some embodiments, the processor may adjust the parameter of the UAV based on the analyzed manned aviation data stream. In some embodiments, the processor may adjust the parameter of the UAV based on the information that is determined relevant to the UAV from the analyzed manned aviation data stream. For example, the processor may adjust a flight parameter of the UAV, such as a flight direction, a flight speed, or an altitude based on the information that is determined relevant to the UAV. In some embodiments, the processor may adjust a sensor parameter of the UAV. In some embodiments, the processor may adjust a camera parameter of the UAV.

Various embodiments provide methods implemented by a processor in a UAV for communicating UAV flight information to a manned aviation information system via the communication equipment available on the UAV. The processor may send UAV flight information to a server or network element of the communication network via the same communication link over which the UAV transmits mission critical communications and/or payload communications. Transmitting UAV flight information in this manner enables the UAV information to be included in manned aviation radio system broadcasts (e.g., ADS-B, Mode S, etc.). In some embodiments, the UAV flight information may include information about the UAV such as one or more of location information, altitude information, course information, speed information, and sensor information from one or more sensors of the UAV.

In some embodiments, the processor may format the UAV flight information into a format that is usable by the manned aviation radio system broadcast. In some embodiments, a server or network element may incorporate the UAV flight information into manned aviation data. In some embodiments, the server or network element may be an element of a manned aviation radio broadcast system (e.g., of an ADS-B system or Mode S system). In some embodiments, the server or network element may store the manned aviation data in a data structure, such as a database or a similar data structure.

In some embodiments, the manned aviation radio system may broadcast the UAV flight information as part of a manned aviation radio system. In some embodiments, the processor may provide authentication credentials together with or in addition to the UAV flight information to verify a permission of the UAV to provide the UAV flight information to the manned aviation information system.

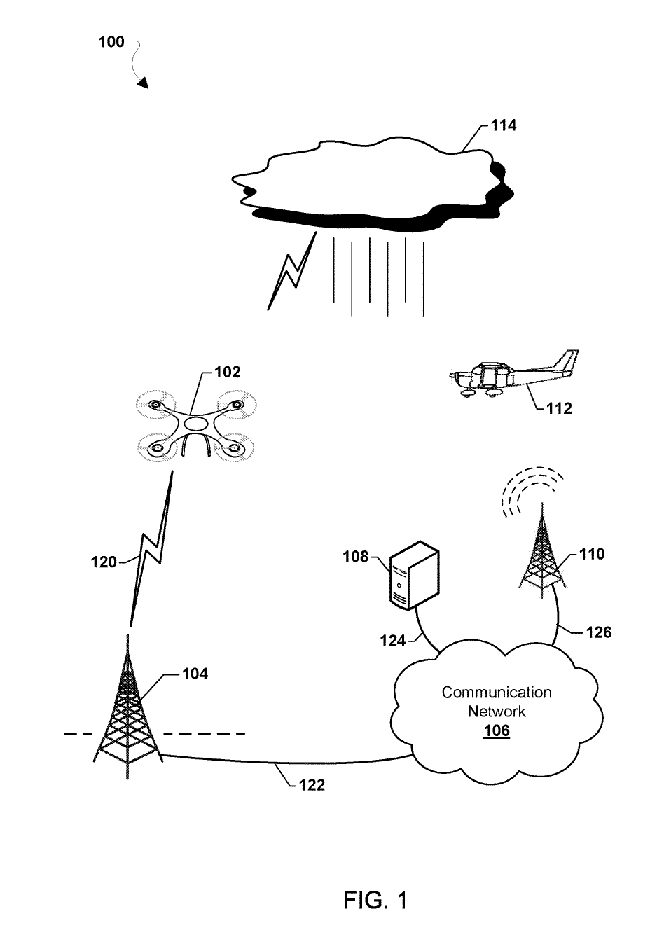

Various embodiments may be implemented within a variety of communication systems 100, an example of which is illustrated in FIG. 1. With reference to FIG. 1, the communication system 100 may include a UAV 102, a base station 104, the communication network 106, a network element 108, and a radio broadcast station 110.

The base station 104 may be a base station or another similar access point, which may provide wireless communications to access the communication network 106 over a wired and/or wireless communications backhaul 122. The base station 104 may include base stations configured to provide wireless communications over a wide area (e.g., macro cells), as well as small cells or a wireless access points, which may include a micro cell, a femto cell, a pico cell, a Wi-Fi access point, and other similar network access points.

The UAV 102 may communicate with the base station 104 over a wireless communication link 120. The wireless communication link 120 may include a plurality of carrier signals, frequencies, or frequency bands, each of which may include a plurality of logical channels. The wireless communication link 120 may utilize one or more radio access technologies (RATs). Examples of RATs that may be used in a wireless communication link include 3GPP Long Term Evolution (LTE), 3G, 4G, 5G, Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

The network element 108, which may be a network server or another similar network element, may include a source (e.g., a database) of manned aviation information. The network element 108 may be included in or part of a manned aviation information system. The network element 108 may also include a server or network element of the communication network 106 that may communicate with a source of manned aviation information, such as a source that is part of the manned aviation information system. The network element 108 may communicate with the communication network 106 over a communication link 124, such as a local area network or the Internet.

The radio broadcast station 110 may communicate with the communication network 106 over communication link 126, such as (but not limited to) the Internet. The radio broadcast station 110 may broadcast information of the manned aviation information system for reception by manned commercial and general aviation aircraft. Manned aviation information may typically include information about local traffic 112. The manned aviation information may also include information about weather conditions 114. The manned aviation information may also include convenience information such as NOTAMs (Notices to Airmen) and other similar information.

The UAV 102 may receive a manned aviation data stream over the communication link 120 using the wireless communication resources available on the UAV 102. The manned aviation data stream may include one or more aspects of the manned aviation information (e.g., information about the local traffic 112, weather conditions 114, and other such information). The manned aviation data stream may be provided by the network element 108 via the communication network 106.

In various embodiments, the UAV 102 may analyze the manned aviation data stream, and may adjust a parameter based on the UAV's analysis of the manned aviation data stream. For example, the UAV 102 may determine the presence of the air traffic 112, although the UAV 102 may be unable to detect air traffic 112 by sensors of the UAV 102 (e.g., a camera, a radio frequency signal sensor, or another similar sensor). The UAV 102 may further determine, for example, that the air traffic 112 requires the UAV 102 to change a parameter (e.g., to avoid the air traffic 112). As another example, the UAV 102 may determine the approach of inclement weather in the weather conditions 114. Accordingly, the UAV 102 may determine to change a parameter to address the determined inclement weather.

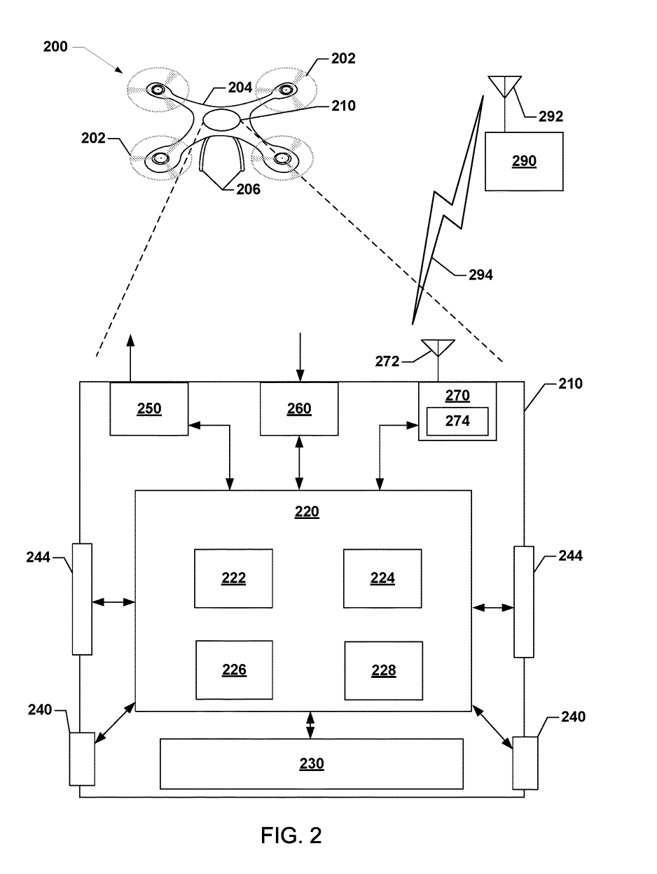

UAVs may include winged or rotorcraft varieties. FIG. 2 illustrates an example UAV 200 of a rotary propulsion design that utilizes one or more rotors 202 driven by corresponding motors to provide lift-off (or take-off) as well as other aerial movements (e.g., forward progression, ascension, descending, lateral movements, tilting, rotating, etc.). The UAV 200 is illustrated as an example of a UAV that may utilize various embodiments, but is not intended to imply or require that various embodiments are limited to rotorcraft UAVs. Instead, various embodiments may be use with winged UAVs as well. Further, various embodiments may equally be used with land-based autonomous vehicles, water-borne autonomous vehicles, and space-based autonomous vehicles.

With reference to FIGS. 1 and 2, the UAV 200 may be similar to the UAV 102. The UAV 200 may include a number of rotors 202, a frame 204, and landing columns 206 or skids. The frame 204 may provide structural support for the motors associated with the rotors 202. The landing columns 206 may support the maximum load weight for the combination of the components of the UAV 200 and, in some cases, a payload. For ease of description and illustration, some detailed aspects of the UAV 200 are omitted such as wiring, frame structure interconnects, or other features that would be known to one of skill in the art. For example, while the UAV 200 is shown and described as having a frame 204 having a number of support members or frame structures, the UAV 200 may be constructed using a molded frame in which support is obtained through the molded structure. While the illustrated UAV 200 has four rotors 202, this is merely exemplary and various embodiments may include more or fewer than four rotors 202.

The UAV 200 may further include a control unit 210 that may house various circuits and devices used to power and control the operation of the UAV 200. The control unit 210 may include a processor 220, a power module 230, sensors 240, payload-securing units 244, an output module 250, an input module 260, and a radio module 270.

The processor 220 may be configured with processor-executable instructions to control travel and other operations of the UAV 200, including operations of various embodiments. The processor 220 may include or be coupled to a navigation unit 222, a memory 224, a gyro/accelerometer unit 226, and an avionics module 228. The processor 220 and/or the navigation unit 222 may be configured to communicate with a server through a wireless connection (e.g., a cellular data network) to receive data useful in navigation, provide real-time position reports, and assess data.

The avionics module 228 may be coupled to the processor 220 and/or the navigation unit 222, and may be configured to provide travel control-related information such as altitude, attitude, airspeed, heading, and similar information that the navigation unit 222 may use for navigation purposes, such as dead reckoning between Global Navigation Satellite System (GNSS) position updates. The gyro/accelerometer unit 226 may include an accelerometer, a gyroscope, an inertial sensor, or other similar sensors. The avionics module 228 may include or receive data from the gyro/accelerometer unit 226 that provides data regarding the orientation and accelerations of the UAV 200 that may be used in navigation and positioning calculations.

The processor 220 may further receive additional information from the sensors 240 that may be used in navigation and positioning calculations. For example, the sensors 240 may include an optical sensor (e.g., capable of sensing visible light, infrared, ultraviolet, and/or other wavelengths of light), a radio frequency (RF) sensor, a camera, a barometer, a sonar emitter/detector, a radar emitter/detector, a microphone or another acoustic sensor, or another sensor that may provide information usable by the processor 220 for navigation and positioning calculations.

Additionally, the sensors 240 may include contact or pressure sensors that may provide a signal that indicates when the UAV 200 has made contact with a surface. The payload-securing units 244 may include an actuator motor that drives a gripping and release mechanism and related controls that are responsive to the control unit 210 to grip and release a payload in response to commands from the control unit 210.

The power module 230 may include one or more batteries that may provide power to various components, including the processor 220, the sensors 240, the payload-securing units 244, the output module 250, the input module 260, and the radio module 270. In addition, the power module 230 may include energy storage components, such as rechargeable batteries. The processor 220 may be configured with processor-executable instructions to control the charging of the power module 230 (i.e., the storage of harvested energy), such as by executing a charging control algorithm using a charge control circuit. Alternatively or additionally, the power module 230 may be configured to manage its own charging. The processor 220 may be coupled to the output module 250, which may output control signals for managing the motors that drive the rotors 202 and other components.

The UAV 200 may be controlled through control of the individual motors of the rotors 202 as the UAV 200 progresses toward a destination. The processor 220 may receive data from the navigation unit 222 and use such data in order to determine the present position and orientation of the UAV 200, as well as the appropriate course towards the destination or intermediate sites. In various embodiments, the navigation unit 222 may include a GNSS receiver system (e.g., one or more global positioning system (GPS) receivers) enabling the UAV 200 to navigate using GNSS signals. Alternatively or in addition, the navigation unit 222 may be equipped with radio navigation receivers for receiving navigation beacons or other signals from radio nodes, such as navigation beacons (e.g., very high frequency (VHF) omni-directional range (VOR) beacons), Wi-Fi access points, cellular network sites, radio station, remote computing devices, other UAVs, etc.

The radio module 270 may be configured to receive navigation signals, such as signals from aviation navigation facilities, etc., and provide such signals to the processor 220 and/or the navigation unit 222 to assist in UAV navigation. In various embodiments, the navigation unit 222 may use signals received from recognizable RF emitters (e.g., AM/FM radio stations, Wi-Fi access points, and cellular network base stations) on the ground. The locations, unique identifiers, signal strengths, frequencies, and other characteristic information of such RF emitters may be stored in a memory and used to determine position (e.g., via triangulation and/or trilateration) when RF signals are received by the radio module 270. For example, the information of the RF emitters may be stored in the memory 224 of the UAV 200, in a ground-based server in communication with the processor 220 via a wireless communication link, or in a combination of the memory 224 and a ground-based server.

The radio module 270 may include a modem 274 and a transmit/receive antenna 272. The radio module 270 may be configured to conduct wireless communications with a variety of wireless communication devices (e.g., wireless communication device 290), examples of which include a wireless telephony base station or cell tower (e.g., the base station 104), a beacon, a smartphone, a tablet, or another computing device with which the UAV 200 may communicate (such as the network element 108). The processor 220 may establish a bi-directional wireless communication link 294 via the modem 274 and the antenna 272 of the radio module 270 and the wireless communication device 290 via a transmit/receive antenna 292. In some embodiments, the radio module 270 may be configured to support multiple connections with different wireless communication devices using different radio access technologies.

The processor 220 may use the radio module 270 to communicate mission-critical communications and payload communications to ground receivers over a common communication channel Mission critical communications may relate to UAV safety and/or security, and may include telemetry (which may include control commands) as well as UAV status information. The mission critical communications may be exchanged between the UAV 200 and a ground station that is designated to maintain control and/or safety of the UAV 200. The UAV status information may include data regarding the UAV's current location, current activities, resource status levels (e.g., power supply levels), and even imaging or sensor data related to mission-critical and or safety operations. The mission critical communications may also include flight commands, flight patterns, information related to local air traffic, and other operational safety information.

Payload communications involve other, non-mission critical communications of the UAV 200 (e.g., typically not relating directly to the safety and/or security of the UAV). The payload communications may include communications with equipment on the UAV 200 for managing one or more mission objectives, other than flying and flight safety. For example, payload communications may configure a sensor payload for measurements (e.g., agricultural crop yield measurements in agricultural settings), or to download collected data files while in flight (such as video recordings unrelated to vehicle control or safety and/or the like).

In various embodiments, the wireless communication device 290 may be connected to a server through intermediate access points. In an example, the wireless communication device 290 may be a server of a UAV operator, a third party service (e.g., package delivery, billing, etc.), or a site communication access point. The UAV 200 may communicate with a server through one or more intermediate communication links, such as a wireless telephony network that is coupled to a wide area network (e.g., the Internet) or other communication devices. In some embodiments, the UAV 200 may include and employ other forms of radio communication, such as mesh connections with other UAVs or connections to other information sources (e.g., balloons or other stations for collecting and/or distributing weather or other data harvesting information).

In various embodiments, the control unit 210 may be equipped with an input module 260, which may be used for a variety of applications. For example, the input module 260 may receive images or data from an onboard camera or sensor, or may receive electronic signals from other components (e.g., a payload).

While various components of the control unit 210 are illustrated as separate components, some or all of the components (e.g., the processor 220, the output module 250, the radio module 270, and other units) may be integrated together in a single device or module, such as a system-on-chip module.

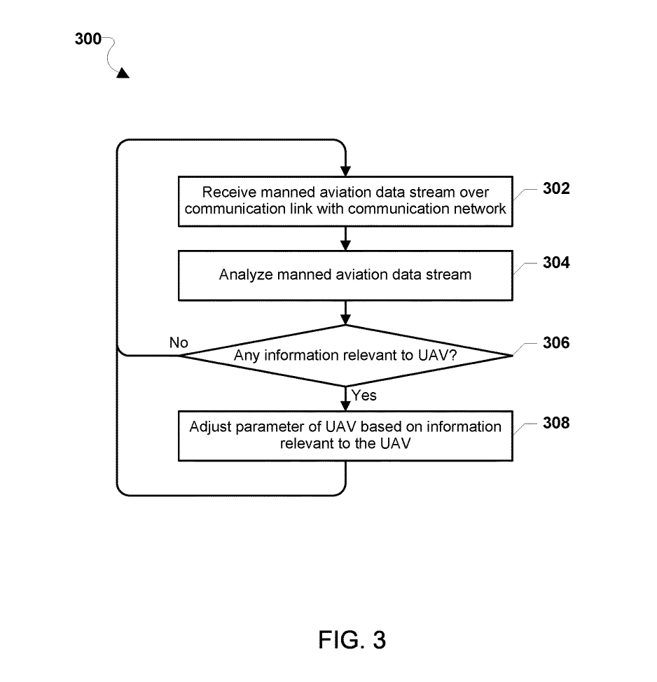

FIG. 3 illustrates a method 300 of managing a parameter of a UAV (e.g., 102, 200 in FIGS. 1 and 2) according to various embodiments. With reference to FIGS. 1-3, the method 300 may be implemented by a processor (e.g., the processor 220 and/or the like) of the UAV.

In block 302, the processor may receive a manned aviation data stream over a communication link with a communication network (e.g., the Internet). In some embodiments, the processor of the UAV may receive the manned aviation data stream over the communication link with the communication network. In some embodiments, the communication network may include a cellular communication network coupled to another network, such as the Internet.

The manned aviation data stream may include information from a manned aviation radio system (such as, for example, the ADS-B system or the Mode S system). The manned aviation data stream may include information such as information about traffic around the UAV (i.e., other vehicles, including manned vehicles and/or other UAVs). The manned aviation data stream may also include information such as weather information, and other information relevant to operations of the UAV, such as NOTAMs and other similar information.

In some embodiments, the processor may periodically access a database of information from the manned aviation radio system e.g., the network element 108) via a communication network (e.g., the communication network 106). In some embodiments, the processor may send a query or access request to a server or network node requesting aviation data, and in response, receive a download of information from a database or from another source of the manned aviation data stream. In some embodiments, the processor may receive a periodic transmission of the information (e.g., a “push”) from the database or other source of the manned aviation data stream.

In some embodiments, the processor may receive the manned aviation data stream in block 302 via the same communication link over which the processor receives mission critical communications and/or payload communications. In some embodiments, the processor may receive the manned aviation data stream, mission critical communications, and/or payload communications over a common communication link with the communication network, such as a wireless telephony cell of the other network or a Wi-Fi network.

In block 304, the processor of the UAV may analyze the manned aviation data stream. For example, the manned aviation data stream may include a digital bit stream, and the processor of the UAV may analyze the digital bit stream. In some embodiments, the UAV may identify one or more types of information in the digital bitstream, such as traffic information, weather information, information about navigational hazards and/or restrictions, or another type of information. In some embodiments, the UAV may assign a priority to the one or more types of information. In some embodiments, the UAV may assign a higher priority to a specific information element in the digital bit stream, such as information indicating an incoming aircraft, or include weather, or navigational hazard or restriction along the flight path of the UAV.

In determination block 306, the processor of the UAV may determine whether there is any information relevant to the UAV in the analyzed manned aviation data stream. In some embodiments, the processor may determine that information is relevant based on a priority assigned to certain information. In some embodiments, the processor may determine that information is relevant based on a localized nature of the information compared to a threshold radius of distance from the UAV (e.g., information that an approaching aircraft is within, or will shortly enter, a threshold radius from the UAV). As another example, the processor may determine that information is relevant based on the relationship of the information to a present and/or projected path of the UAV. For example, the processor may that a storm is relevant if the storm will intersect flight path of the UAV, or that the UAV will travel within a threshold distance of the storm. As another example, the processor may determine that an area of restricted airspace is relevant because the flight path of the UAV will intersect the restricted airspace.

In response to determining that there is no information relevant to the UAV in the analyzed manned aviation data stream (i.e., determination block 306=“No”), the processor may continue to receive the manned aviation data stream in block 302.

In response to determining that there is information relevant to the UAV in the analyzed manned aviation data stream (i.e., determination block 306=“Yes”), the processor may adjust a parameter of the UAV based on the information in the manned aviation data stream that is relevant to the UAV in block 308.

In some embodiments, the processor may adjust a flight parameter of the UAV based on the analyzed manned aviation data stream. For example, the processor may change one or more of a flight direction or flight path, a flight speed, and an altitude based on the information that is relevant to the UAV. As another example, the processor may control the UAV to descend to a charging station, seek shelter, avoid a collision, change a planned route to a destination, avoid an approaching weather event, make an emergency landing, or another behavior (which may include a set of behaviors or a sequence of behaviors). In some embodiments, adjusting the parameter may include adjusting one or more specific parameters, such as direction, speed, or altitude. In some embodiments, adjusting the parameter may include initiating a preset behavior or instruction set involving two or more parameter adjustments.

In some embodiments, the processor may adjust a sensor parameter of a sensor of the UAV based on the analyzed manned aviation data stream. For example, the processor may activate or deactivate a sensor of the UAV (e.g., a temperature sensor, humidity sensor, or windspeed sensor, e.g., in response to an indication of inclement weather). The processor may adjust one or more aspects of a sensor, including a sensitivity, a focus, a range (e.g., a radius of scanning from the UAV), a scan direction, a scan angle, a scan periodicity or frequency that a scan is performed, a scan point or range (e.g., a scanned frequency or frequency range, temperature or temperature range, humidity or humidity range, direction or range of directions), and the like.

In some embodiments, the processor may adjust a camera parameter of a camera of the UAV based on the analyzed manned aviation data stream. For example, the processor may activate or deactivate a camera, adjust one or more of a focal length, a zoom, a camera direction, a camera angle relative to an aspect of the UAV (e.g., relative to the UAV's direction of motion, flight angle, pitch, yaw, roll, orientation relative to the direction of gravity, altitude, or another similar aspect of the UAV).

In various embodiments, the processor may adjust one or more of the flight parameter, the sensor parameter, or the camera parameter based on the information in the manned aviation data stream.

The processor may then continue to receive the manned aviation data stream in block 302. Thus, the processor may iteratively monitor the manned aviation data stream and may adjust a fight parameter based on information relevant to the UAV identified in the manned aviation data stream.

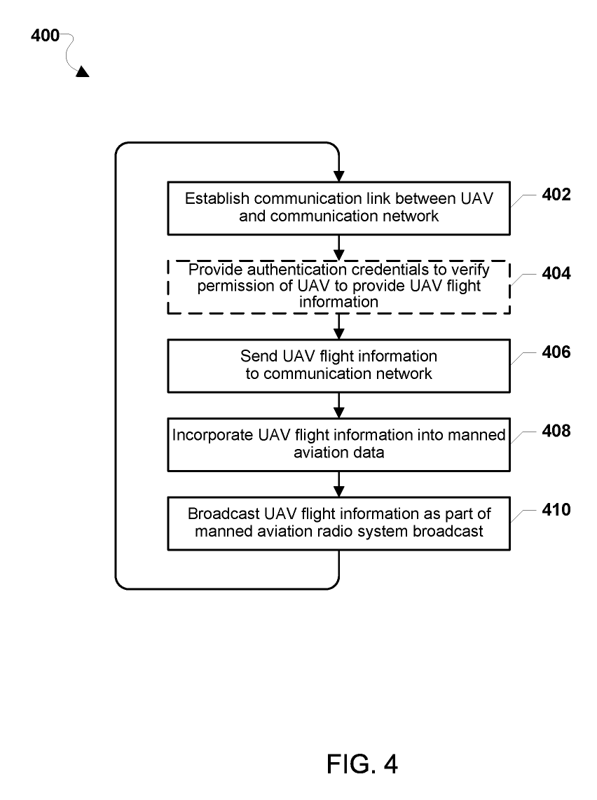

FIG. 4 illustrates a method 400 of communicating flight information from a UAV (e.g., 102, 200 in FIGS. 1 and 2) to a manned aviation information system using communication resources available to the UAV according to various embodiments. With reference to FIGS. 1-4, the method 400 may be implemented by a processor (e.g., the processor 220 and/or the like) of the UAV.

In block 402, the processor may establish a communication link between the UAV and a communication network. For example, the processor may establish a communication link 120 between the UAV 102 and a base station 104 of a wireless telephony network coupled to the Internet, and then access a server or network element (e.g., the network element 108) via conventional Internet communication protocols (e.g., TCP/IP).

In optional block 404, the processor may provide authentication credentials to a server or network element to verify that the UAV has permission to provide UAV flight information to a manned aviation information system. For example, the processor may provide authentication credentials to a server or network element (e.g., the network element 108) in order to verify to the network element that the UAV is authorized to provide the UAV flight information to the manned aviation information system.

In block 406, the processor may send the UAV flight information to the server or network element of the communication network. In some embodiments, the processor may send the UAV flight information to the server or network element (e.g., the network element 108) via a communication network (106), such as the Internet. The UAV flight information may include one or more of the UAV's location, altitude, heading, and speed, as well as information gathered by one or more of the UAV's sensors.

In some embodiments, sending the UAV flight information to the communication network may include formatting the UAV flight information into a format that is usable by the manned aviation radio system. For example, the manned aviation radio system may utilize a particular data format or structure for storage and/or transmission of manned aviation information. In some embodiments, the processor may format the UAV flight information into a data format or structure of the manned aviation information system and may send the formatted UAV flight information to the communication network.

In block 408, the UAV flight information may be incorporated into the manned aviation data by the receiving server or network element. For example, a network element of a manned communication network (e.g., the network element 108) may incorporate or include the UAV flight information into the manned aviation data.

In block 410, the UAV flight information may be broadcast as part of a manned aviation radio system broadcast. For example, the incorporated UAV flight information may be broadcast from a radio broadcast station (e.g., the radio broadcast station 110). The broadcasted UAV flight information may be received by manned vehicles and/or other UAVs. The broadcasted UAV flight information may be acted upon by a manned vehicle or another UAV, e.g., to avoid interfering with a mission of the UAV (i.e., the UAV that sent the UAV flight information to the communication network), or to avoid collision with the UAV. Thus, the UAV flight information may supplement and improve the manned aviation information that is provided by the manned aviation radio system.

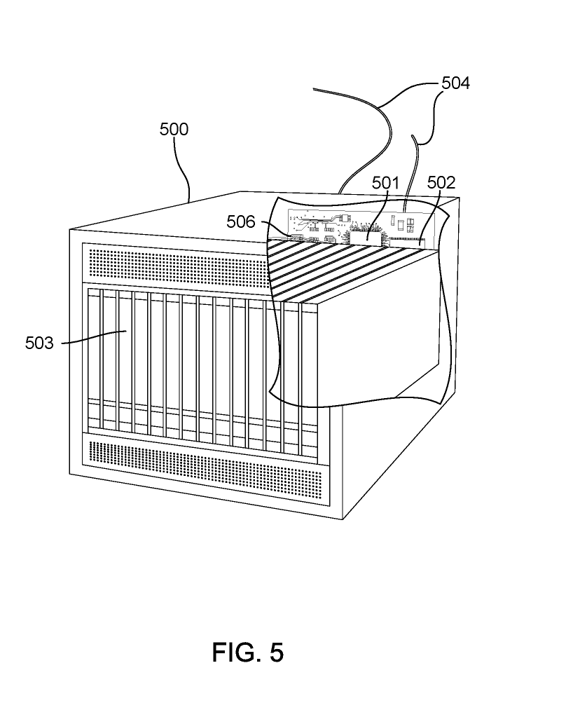

In various embodiments, the processor of the UAV receives data from and/or communicates with a server or network element (e.g., the network element 108) of a communication network (e.g., the communication network 106). Such a server or network element may typically include, at least, the components illustrated in FIG. 5, which illustrates an example server 500. With reference to FIGS. 1-5, the server 500 may typically include a processor 501 coupled to volatile memory 502 and a large capacity nonvolatile memory, such as a disk drive 503. The server 500 may also include a floppy disc drive, compact disc (CD) or digital video disc (DVD) drive 506 coupled to the processor 501. The server 500 may also include network access ports 504 (e.g., one or more network interfaces) coupled to the processor 501 for establishing data connections with a network, such as the Internet and/or a local area network coupled to other system computers and servers. Similarly, the server 500 may include additional access ports, such as USB, Firewire, Thunderbolt, and the like for coupling to peripherals, external memory, or other devices.

Various embodiments enable the processor of the UAV to manage a parameter of the UAV based on manned aviation data. Various embodiments further enable communication of the UAV flight information to a manned aviation information system. Various embodiments enable the UAV to receive manned aviation information without carrying an additional impractical and expensive radio for receiving the information via aviation radio links. Various embodiments improve the operation of the UAV by providing additional, potentially vital information to the UAV, enabling the processor of the UAV to make parameter adjustments with increased accuracy, thereby improving the safety and efficiency of UAV operations. Various embodiments also improve the operation of the manned aviation information system by increasing the amount and accuracy of information available, through the incorporation of the UAV flight information, thereby improving the safety and efficiency of vehicular operations (both manned and unmanned).

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 300 and 400 may be substituted for or combined with one or more operations of the methods 300 and 400, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

What is claimed is:

1. A method of managing a parameter of an unmanned autonomous vehicle (UAV) based on manned aviation data, comprising:
receiving over a communication link with a communication network a manned aviation data stream;
analyzing the manned aviation data stream; and
adjusting a parameter of the UAV based on the analyzed manned aviation data stream.

2. The method of claim 1, wherein adjusting the parameter of the UAV based on the analyzed manned aviation data stream comprises:
determining whether information relevant to the UAV is included in the analyzed manned aviation data stream; and
adjusting the parameter of the UAV based on the information relevant to the UAV in response to determining that information relevant to the UAV is included in the analyzed manned aviation data stream.

3. The method of claim 1, wherein adjusting the parameter of the UAV based on the analyzed manned aviation data stream comprises:
adjusting a flight parameter of the UAV based on the analyzed manned aviation data stream.

4. The method of claim 1, wherein adjusting the parameter of the UAV based on the analyzed manned aviation data stream comprises:
adjusting a sensor parameter of the UAV based on the analyzed manned aviation data stream.

5. The method of claim 1, wherein adjusting the parameter of the UAV based on the analyzed manned aviation data stream comprises:
adjusting a camera parameter of the UAV based on the analyzed manned aviation data stream.

6. The method of claim 1, wherein the communication link with the communication network comprises a cellular data communication link.

7. The method of claim 1, wherein the communication network is the Internet.

8. The method of claim 1, wherein receiving over the communication link with the communication network the manned aviation data stream comprises receiving the manned aviation data stream over the same communication link over which one of mission critical communications and payload communications is received.

9. The method of claim 1, wherein receiving over the communication link with the communication network the manned aviation data stream comprises receiving the manned aviation data stream from a network element of the communication network.

10. The method of claim 1, wherein the manned aviation data stream comprises information from a manned aviation radio system.

11. The method of claim 10, wherein the information from the manned aviation radio system comprises Automatic Dependent Surveillance-Broadcast (ADS-B) data or Mode S transponder system data.

12. The method of claim 1, wherein adjusting the parameter of the UAV based on the analyzed manned aviation data stream comprises changing one or more of a flight direction, a flight speed, and an altitude based on the analyzed manned aviation data stream.

13. An unmanned autonomous vehicle (UAV), comprising:
a radio module;
an avionics module; and
a processor coupled to the radio module and the avionics module and configured with processor-executable instructions to:
receive over a communication link with a communication network a manned aviation data stream;
analyze the manned aviation data stream; and
adjusting a parameter of the UAV based on the analyzed manned aviation data stream.

14. The UAV of claim 13, wherein the processor is further configured to:
determine whether information relevant to the UAV is included in the analyzed manned aviation data stream; and
adjust the parameter of the UAV based on the information relevant to the UAV in response to determining that information relevant to the UAV is included in the analyzed manned aviation data stream.

15. The UAV of claim 13, wherein the processor is further configured such that the communication link with the communication network comprises a cellular data communication link.

16. The UAV of claim 13, wherein the processor is further configured to receive the manned aviation data stream over the same communication link over which one of mission critical communications and payload communications is received.

17. The UAV of claim 13, wherein the processor is further configured to receive the manned aviation data stream from a network element of the communication network.

18. The UAV of claim 13, wherein the processor is further configured such that the manned aviation data stream comprises information from a manned aviation radio system.

19. The UAV of claim 13, wherein the processor is further configured to change one or more of a flight direction, a flight speed, and an altitude based on the analyzed manned aviation data stream.

20. A method of communicating flight information from an unmanned autonomous vehicle (UAV) to a manned aviation information system, comprising:
establishing a communication link between the UAV and a communication network; and
sending UAV flight information to a network element of the communication network for inclusion in a broadcast by a manned aviation information system.

21. The method of claim 20, wherein sending UAV flight information to a network element of the communication network comprises sending the UAV flight information over the same communication link over which one of mission critical communications and payload communications is transmitted.

22. The method of claim 20, wherein establishing the communication link between the UAV and the communication network comprises providing authentication credentials to verify a permission of the UAV to provide the UAV flight information to the manned aviation information system.

23. The method of claim 20, wherein sending the UAV flight information to a network element of the communication network for inclusion in the broadcast of a manned aviation radio system comprises formatting the UAV flight information into a format usable by the manned aviation radio system.

24. The method of claim 20, wherein the UAV flight information includes one or more of location information, altitude information, course information, speed information, and sensor information.

25. The method of claim 20, wherein the communication link between the UAV and a communication network comprises a cellular data communication link.

26. A system for communicating flight information from an unmanned autonomous vehicle (UAV) to a manned aviation information system, comprising:
a UAV, comprising:
a radio module;
an avionics module; and
a processor coupled to the radio module and the avionics module and configured with processor-executable instructions to:
establish a communication link between the UAV and a communication network; and
send UAV flight information to a network element of the communication network for inclusion in a broadcast by a manned aviation information system.

27. The system of claim 26, wherein the processor of the UAV is further configured to send the flight information over the same communication link over which one of mission critical communications and payload communications is transmitted.

28. The system of claim 26, wherein the processor of the UAV is further configured to provide authentication credentials to verify a permission of the UAV to provide the UAV flight information to the manned aviation information system.

29. The system of claim 26, wherein the processor of the UAV is further configured to format the UAV flight information into a format usable by the manned aviation information system.

30. The system of claim 26, wherein the processor of the UAV is further configured such that the UAV flight information includes one or more of location information, altitude information, course information, speed information, and sensor information.
